(19) United States
(12) Patent Application Publication
(10) Pub. No.: US 2013/0141575 A1
(43) Pub. Date: Jun. 6, 2013

(54) DRIVING ASSISTANCE SYSTEM AND METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/326,238

(22) Filed: Dec. 14, 2011

(30) Foreign Application Priority Data
Dec. 2, 2011 (TW) 100144274

(51) Int. Cl. H04N 7/18

(52) U.S. Cl. 348/148; 348/E07.085

(57) ABSTRACT

An exemplary driving assistance method includes obtaining images captured by a plurality of cameras, each of the images comprising a distance information indicating a distance between one camera and objects captured by the camera. Next, the method extracts the distance information from the obtained images. The method further includes detecting whether a road surface or a road width is abnormal according to the extracted distance information and the captured image. Lastly, the method generates a prompt message to warn a driver when the road surface or the road width is abnormal.

### BACKGROUND

1. Technical Field

The present disclosure relates to driving assistance systems and methods, and particularly, to a driving assistance system and method for detecting surrounding environment of a vehicle.

2. Description of Related Art

Navigation devices are widely used in motor vehicles to guide a driver. However, when a driver drives the vehicle in dark conditions, the driver cannot see far ahead. In that situation, an unseen potholes on the road surface may damage the vehicle. Furthermore, the navigation device cannot provide the driver with the information of road width. Therefore, it is desirable to provide a driving assistance system to overcome the above problems.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic diagram illustrating a driving assistance device connected with two cameras, and an input device in accordance with an exemplary embodiment.

FIG. 2 is a block diagram of a driving assistance system of FIG. 1.

FIG. 3 is an illustrative diagram showing the driving assistance system executing the road surface detection function in accordance with an exemplary embodiment.

FIG. 4 is a flowchart of a driving assistance method in accordance with an exemplary embodiment.

### DETAILED DESCRIPTION

The embodiments of the present disclosure are now described in detail, with reference to the accompanying drawings.

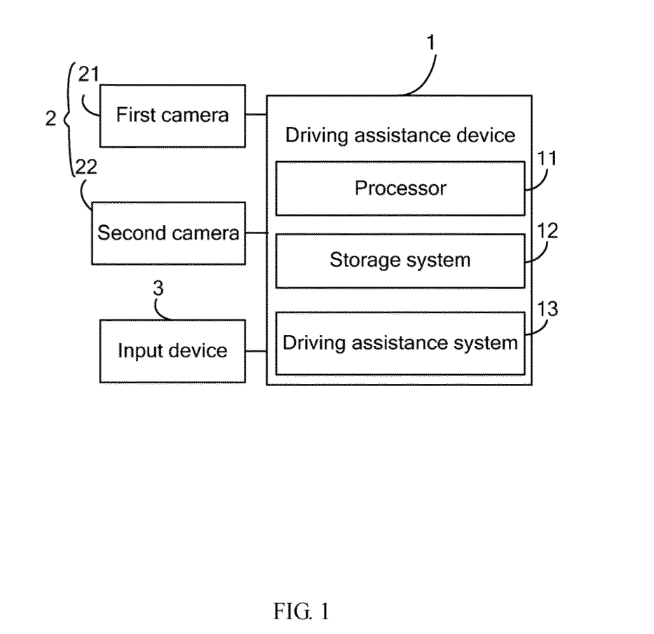

FIG. 1 is a schematic diagram illustrating a driving assistance device 1. The driving assistance device 1 is connected to a number of cameras 2 and an input device 3 and is capable of executing a number of detection functions. The driving assistance device 1 can obtain images captured by one of the cameras 2 in response to a user selection of one of the detection functions, and can further determine whether the surrounding environment is abnormal. The driving assistance device 1 can further generate a prompt message to warn the driver that the surrounding environment is abnormal.

Each captured image includes distance information indicating the distance between one camera 2 and its captured objects for each pixel of the image. In the embodiment, the camera 2 is a Time of Flight (TOF) camera. In the embodiment, the cameras 2 include a first camera 21 and a second camera 22. The first camera 21 and the second camera 22 are both mounted on the front of the vehicle. The first camera 21 takes images of the road surface in front of the vehicle. The second camera 22 takes images of the frontal environment.

In the embodiment, the detection functions include a road surface detection function and a road width detection function. The images captured by the first camera 21 are utilized by the road surface detection function, and the images captured by the second camera 22 are utilized by the road width detection function.

The driving assistance device 1 includes at least one processor 11, a storage system 12, and a driving assistance system 13. In the embodiment, there is one processor 11. In an alternative embodiment, there may be more than one processor 11.

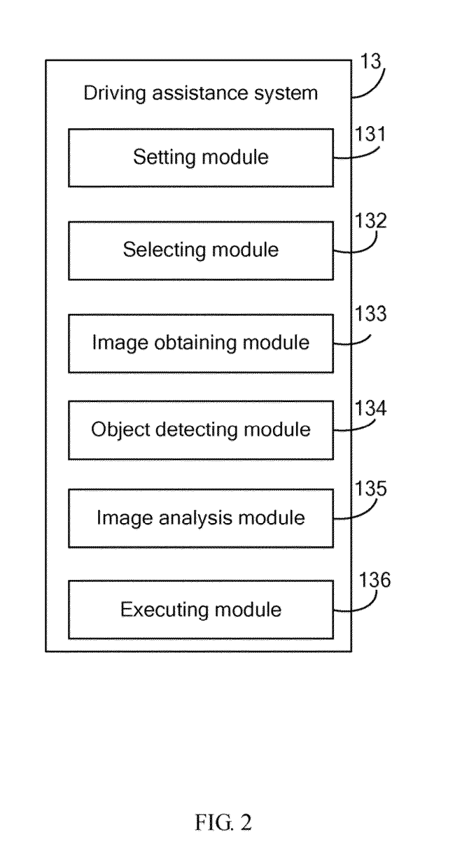

Referring to FIG. 2, in the embodiment, the driving assistance system 13 includes a setting module 131, a selection module 132, an image obtaining module 133, an object detection module 134, an image analysis module 135, and an executing module 136. One or more programs of the above function modules may be stored in the storage system 12 and executed by the processor 11. In general, the word “module,” as used herein, refers to logic embodied in hardware or firmware, or to a collection of software instructions, written in a programming language. The software instructions in the modules may be embedded in firmware, such as an erasable programmable read only memory (EPROM). The modules described herein may be implemented as either software and/or hardware modules and may be stored in any type of computer-readable medium or other storage device.

The setting module 131 inputs a value (hereinafter vehicle width) representing the width of the vehicle. The vehicle width can be input when the system 13 is run for the first time, and can be changed later.

The selection module 132 provides an interface for the user to select one detection function from the road surface detection function and the road width detection function, and further to generate a corresponding road surface detection signal or a road width detection signal in response to the user selection.

The image obtaining module 133 receives the road surface detection signal from the selection module 132, and further obtains the images captured by the first camera 21.

The object detecting module 134 extracts the distance information that indicates the distance between the cameras 2 and the captured objects from the captured images. In the embodiment, the object detecting module 134 extracts the distance information using Robust Real-time Object Detection Method which is well-known to the person having ordinary skill in the art.

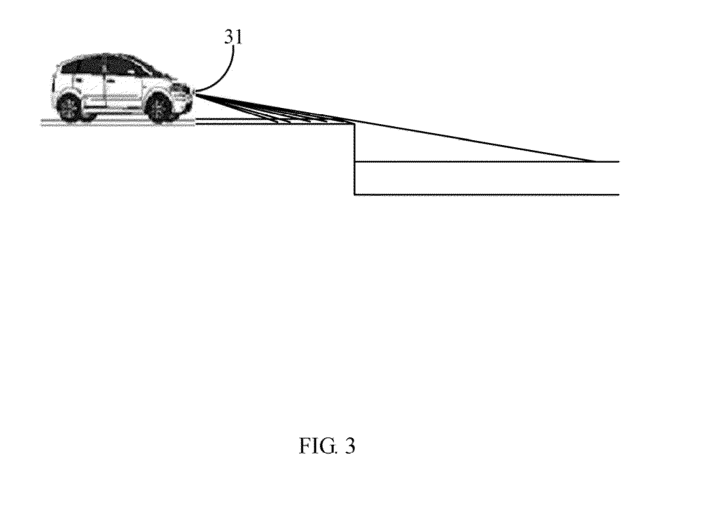

FIG. 3 shows the image analysis module 135 comparing the distance information of each two adjacent pixels of one of the captured images, determining whether a distance difference between the distances indicated by the two adjacent pixels is more than a preset range, and further determining whether the number of the determined two adjacent pixels is more than a preset value.

The executing module 136 generates a prompt message to warn the user that the road surface is abnormal when the number of the determined two adjacent pixels is more than the preset value.

The image obtaining module 133 receives the road width detection signal from the selection module 132, and further obtains the images captured by the second camera 22.

The object detecting module 134 extracts the distance information that indicates the distance between the second camera 22 and the captured objects from the captured images. In the embodiment, the object detecting module 134 extracts the distance information using Robust Real-time Object Detection Method.

The image analysis module 135 determines the pixels of one of the captured images whose distance information indicates a distance exceeding a preset value, such as 10 meters, determines the areas which is covered by the determined pixels, determines the largest width of the determined areas on a same row to calculate the road width, and further determines whether the road width is greater than the vehicle width input by the user. Herein, the determined area consisting of the pixels whose distance information indicates a distance exceeding the preset value represents that there is no barrier in the determined area.

The executing module 136 generates a prompt message to warn the driver that the largest width is less than the preset vehicle width.

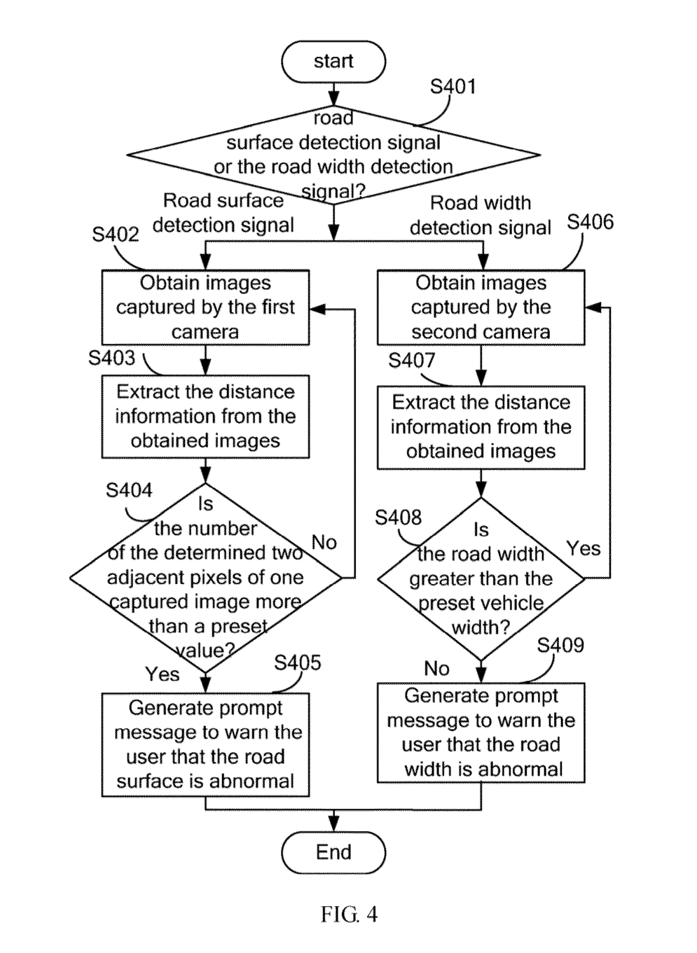

Referring to FIG. 4, a driving assistance method in accordance with an exemplary embodiment is shown. The driving assistance method is implemented by the driving assistance system 13 as shown in FIG. 1.

In step S401, the selection module 132 provides an interface for the user to select one function from the road surface detection function and the road width detection function, and further generates a corresponding road surface detection signal or a road width detection signal in response to the user selection. If the selection module 132 generates the road surface detection signal, the procedure goes to step S402. If the selection module 132 generates the road width detection signal, the procedure goes to step S407.

In step S402, the image obtaining module 133 receives the road surface detection signal, and obtains the images captured by the first camera 21.

In step S403, the object detecting module 134 extracts the distance information that indicates the distance between the first camera 21 and the captured objects from the captured images.

In step S404, the image analysis module 135 compares the distance information of each two adjacent pixels of one of the captured images, determines a distance difference between the distances indicated by the two adjacent pixels is more than a preset range, and further determines whether the number of the determined two adjacent pixels is more than a preset value. If the number of the determined two adjacent pixels is more than the preset value, the procedure goes to step S405. If the number of the determined two adjacent pixels is less than the preset value, the procedure goes to step S402.

In step S405, the executing module 136 generates a prompt message to warn the user that the road surface is abnormal.

In step S406, the image obtaining module 133 receives the road width detection signal, and obtains the images captured by the second camera 22.

In step S407, the object detecting module 132 extracts the distance information that indicates the distance between the second camera 22 and the captured objects from the captured images.

In step S408, the image analysis module 135 determines the pixels of one of the captured images whose distance information indicates a distance exceeding a preset value. Determines the areas which is covered by the determined pixels, determines the largest width of the determined areas on a same row to calculate a road width, and further determines whether the road width is greater than the preset vehicle width. If the road width is greater than the set width of the vehicle, the procedure goes to step S406. If the road width is less than the set width of the vehicle, the procedure goes to step S409.

In step S409, the executing module 136 generates a prompt message to warn the user that the road width is abnormal.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A driving assistance device comprising:
a storage system;
a processor;
one or more programs stored in the storage system, executable by the processor, the one or more programs comprising:
an image obtaining module operable to obtain images captured by a plurality of cameras, each of the images comprising a distance information indicating a distance between one of the cameras and objects captured by the camera;
an object detecting module operable to extract the distance information from the obtained images;
an image analysis module operable to detect whether a road surface or a road width is abnormal according to the extracted distance information and the captured image; and
an executing module operable to generate a prompt message to warn a driver when the road surface or the road width is abnormal.

2. The driving assistance device as described in claim 1, further comprising a selection module, the images captured by a different one of the cameras being utilized for different detection function, wherein the selection module is operable to provide an interface for a user to select a detection function and further generate a corresponding detection signal in response to a user selection, the image obtaining module is operable to obtain the images captured by one of the cameras corresponding to the selected detection function, and the image analysis module is operable to determine whether the road surface or the road width is abnormal according to the obtained images and the selected function.

3. The driving assistance device as described in claim 2, wherein the selection module is operable to generate a road surface detection signal in response to a road surface detection function selected by a user, the image obtaining module is operable to obtain images captured by one of the cameras corresponding to the road surface detection function, the image analysis module is operable to compare the distance information of each of two adjacent pixels of one of the images, determine whether a distance difference between the distances indicated by the two adjacent pixels is more than a preset range, and further determine whether the number of the determined two adjacent pixels is more than a preset value, the executing module is operable to generate a prompt message to warn the user that the road surface is abnormal when the number of the determined two adjacent pixels is more than the preset value.

4. The driving assistance device as described in claim 2, wherein the selection module is operable to generate a road width detection signal in response to a road width detection function selected by a user, the image obtaining module is operable to obtains image captured by one of the cameras corresponding to the road width detection function, the image analysis module is operable to determine pixels of one of the captured images whose distance information indicating a distance that exceeds a preset value, determine the areas which is covered by the determined pixels, determine the largest width of the determined areas on a same row to determine a road width, and further determine whether the road width is greater than a preset vehicle width, the executing module is operable to generate a prompt message to warn the user that the road width is abnormal.

5. The driving assistance device as described in claim 4, further comprising a setting module, wherein the setting module is operable to input a value to be the preset vehicle width.

6. A driving assistance method comprising:
obtaining images captured by a plurality of cameras, each of the images comprising a distance information indicating a distance between one of the cameras and objects captured by the camera;
extracting the distance information from the obtained images;
detecting whether a road surface or a road width is abnormal according to the extracted distance information and the captured image; and
generating a prompt message to warn a driver when the road surface or the road width is abnormal.

7. The driving assistance method as described in claim 6, the images captured by a different one of the cameras being utilized for different detection function, wherein the method comprises:
providing an interface for a user to select a detection function and further generating a corresponding detection signal in response to a user selection;
obtaining the images captured by one of the cameras corresponding to the selected detection function; and
determining whether the road surface or the road width is abnormal according to the obtained images and the selected function.

8. The driving assistance method as described in claim 7, wherein the method further comprises:
generating a road surface detection signal in response to a road surface detection function selected by a user;
obtaining images captured by one of the cameras corresponding to the road surface detection function;
comparing the distance information of each of two adjacent pixels of one of the images, determining whether a distance difference between the distances indicated by the two adjacent pixels is more than a preset range, and further determining whether the number of the determined two adjacent pixels is more than a preset value;
generating a prompt message to warn the user that the road surface is abnormal when the number of the determined two adjacent pixels is more than the preset value.

9. The driving assistance method as described in claim 7, wherein the method further comprises:
generating a road width detection signal in response to a road width detection function selected by a user;
obtaining images captured by one of the cameras corresponding to the road width detection function;
determining pixels of one of the captured images whose distance information indicating a distance that exceeds a preset value, determining the areas which is covered by the determined pixels, determining the largest width of the determined areas on a same row to determine a road width, and further determining whether the road width is greater than a preset vehicle width;
generating a prompt message to warn the user that the road width is abnormal.

10. The driving assistance method as described in claim 9, wherein the method further comprises:
inputting a value to be the preset vehicle width.

11. A storage medium storing a set of instructions, the set of instructions capable of being executed by a processor of a dassistance device, cause the driving assistance device to perform a driving assistance method, the method comprising:
obtaining images captured by a plurality of cameras, each of the images comprising a distance information indicating a distance between one of the cameras and objects captured by the camera;
extracting the distance information from the obtained images;
detecting whether a road surface or a road width is abnormal according to the extracted distance information and the captured image; and
generating a prompt message to warn a driver when the road surface or the road width is abnormal.

12. The storage medium as described in claim 11, the images captured by a different one of the cameras being utilized for different detection function, wherein the method comprises:
providing an interface for a user to select a detection function and further generating a corresponding detection signal in response to a user selection;
obtaining the images captured by one of the cameras corresponding to the selected detection function;
determining whether the road surface or the road width is abnormal according to the obtained images and the selected function.

13. The storage medium as described in claim 12, wherein the method further comprises:
generating a road surface detection signal in response to a road surface detection function selected by a user;
obtaining images captured by one of the cameras corresponding to the road surface detection function;
comparing the distance information of each of two adjacent pixels of one of the images, determining whether a distance difference between the distances indicated by the two adjacent pixels is more than a preset range, and further determining whether the number of the determined two adjacent pixels is more than a preset value;
generating a prompt message to warn the user that the road surface is abnormal when the number of the determined two adjacent pixels is more than the preset value.

14. The storage medium as described in claim 12, wherein the method further comprises:
generating a road width detection signal in response to a road width detection function selected by a user;
obtaining images captured by one of the cameras corresponding to the road width detection function;
determining pixels of one of the captured images whose distance information indicating a distance that exceeds a preset value, determining the areas which is covered by the determined pixels, determining the largest width of the determined areas on a same row to determine a road width, and further determining whether the road width is greater than a preset vehicle width;
generating a prompt message to warn the user that the road width is abnormal.

15. The storage medium as described in claim 14, wherein the method further comprises:
inputting a value to be the preset vehicle width.
